(19) United States
(12) Patent Application Publication
(10) Pub. No.: US 2026/0185500 A1
(43) Pub. Date: Jul. 2, 2026

(54) Solenoid Valve Mechanism and Fuel Pump

(71) Applicant: Hitachi Astemo, Ltd., Hitachinaka-shi, Ibaraki (JP)

(72) Inventors: Akira IIZUKA, Hitachinaka-shi, Ibaraki (JP); Shigehiko OMATA, Hitachinaka-shi, Ibaraki (JP); Atsushi TAKAOKU, Hitachinaka-shi, Ibaraki (JP); Moritsugu AKIYAMA, Hitachinaka-shi, Ibaraki (JP)

(21) Appl. No.: 18/855,389

(22) PCT Filed: Jun. 7, 2022
(86) PCT No.: PCT/JP2022/022873

§ 371 Date: Oct. 9, 2024

(51) Int. Cl. F02M 59/46; F02M 59/02

(52) U.S. Cl. CPC F02M 59/466; F02M 59/027

(57) ABSTRACT

The present invention suppresses wear of a rod or a component with which the rod comes in contact. A solenoid suction valve mechanism (solenoid valve mechanism) includes a suction valve (valve), a rod engaged with the suction valve, and a magnetic attractive force generating unit that generates a magnetic attractive force that causes the rod to move in an axial direction. The rod is provided with a low-friction part. The low-friction part has a friction coefficient set such that a frictional force created between the rod and a rod contact component with which the rod comes in contact is smaller than a rotational propulsive force of the rod.

### TECHNICAL FIELD

The present invention relates to a solenoid valve mechanism and a fuel pump including the solenoid valve mechanism.

### BACKGROUND ART

A solenoid valve mechanism of a fuel pump is described in, for example, PTL 1. In the solenoid valve mechanism (solenoid mechanism) described in PTL 1, a rubber material is press-fitted into a housing part formed in a fixed core. The rubber material buffers impact caused by cavitation collapse that occurs in the fixed core. As a result, the occurrence of cavitation and erosion is suppressed.

### CITATION LIST

### Patent Literature

PTL 1: WO 2020/100398 A

### SUMMARY OF INVENTION

### Technical Problem

However, in the solenoid valve mechanism described in PTL 1, the housing part of the fixed core made of a metal material is filled with a fuel. For this reason, cavitation and erosion cannot be suppressed in the housing part of the fixed core as a whole.

In view of the above problem, an object of the present invention is to provide a solenoid valve mechanism and a fuel pump that can suppress cavitation and erosion that occur in a fixed core.

### Solution to Problem

In order to solve the above problem and achieve the object of the present invention, a solenoid valve mechanism of the present invention includes: a valve; a rod engaged with the valve; a movable core engaged with the rod; a fixed core that generates a magnetic attractive force between the fixed core and the movable core; and a rod biasing spring that biases the rod in the direction of separating the rod away from the fixed core. The fixed core includes: a first recess having a bottom surface with which one end of the rod biasing spring comes in contact; a second recess formed on the bottom surface of the first recess; and an elastic member housed in the second recess. The elastic member covers the whole of an inner wall surface of the second recess.

A fuel pump of the present invention include: a body provided with a pressurized chamber; a plunger supported by the body in such a way as to be capable of reciprocation, the plunger increasing and decreasing a capacity of the pressurized chamber by the reciprocation; and the solenoid valve mechanism that discharges a fuel to the pressurized chamber.

### Advantageous Effects of Invention

According to the solenoid valve mechanism and the fuel pump configured in the above manner, cavitation and erosion that occur in a fixed core can be suppressed.

Problems, configurations, and effects other than those described above will be made clear by the following description of embodiments.

### BRIEF DESCRIPTION OF DRAWINGS

FIG. 1 is an overall configuration diagram of a fuel supply system using a high-pressure fuel supply pump according to a first embodiment of the present invention.

FIG. 2 is a vertical sectional view of the high-pressure fuel supply pump according to the first embodiment of the present invention.

FIG. 3 is a horizontal sectional view of the high-pressure fuel supply pump according to the first embodiment of the present invention, the horizontal sectional view being seen from above.

FIG. 4 is a vertical sectional view of the high-pressure fuel supply pump according to the first embodiment of the present invention, the vertical sectional view being seen from a direction different from a direction in which the vertical sectional view of FIG. 2 is seen.

FIG. 5 is a vertical sectional view of a solenoid valve mechanism according to the first embodiment of the present invention.

FIGS. 6A and 6B depict a mechanism by which cavitation and erosion occur in a recess of a fixed core when the fixed core and a movable core come in contact with each other.

FIGS. 7A and 7B depict the mechanism by which cavitation and erosion occur in the recess of the fixed core when the fixed core and the movable core come in contact with each other.

FIGS. 8A and 8B depict a mechanism by which cavitation and erosion occur in the recess of the fixed core when the fixed core and the movable core separate away from each other.

FIGS. 9A and 9B depict the mechanism by which cavitation and erosion occur in the recess of the fixed core when the fixed core and the movable core separate away from each other.

FIGS. 10A and 10B depict a conceptual view of a vibration-type cavitation test device and a test result, respectively.

FIG. 11 is an enlarged vertical view of the fixed core of the solenoid valve mechanism according to the first embodiment of the present invention.

FIG. 12 is an enlarged vertical view of a fixed core of a solenoid valve mechanism according to a second embodiment of the present invention.

FIG. 13 is an enlarged vertical view of a fixed core of a solenoid valve mechanism according to a third embodiment of the present invention.

FIG. 14 is an enlarged vertical view of a fixed core of a solenoid valve mechanism according to a fourth embodiment of the present invention.

### DESCRIPTION OF EMBODIMENTS

### 1. First Embodiment

Hereinafter, a solenoid valve mechanism and a high-pressure fuel supply pump according to a first embodiment of the present invention will be described. In the drawings, the same members are denoted by the same reference signs.

### [Fuel Supply System]

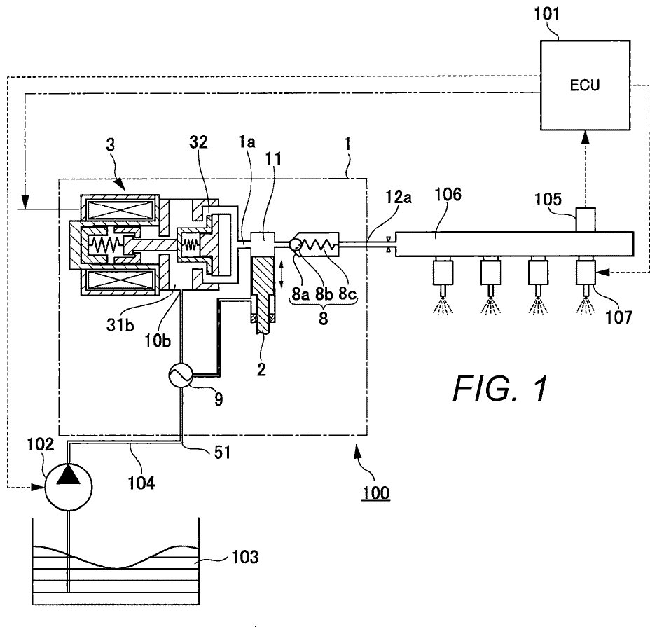

First, a fuel supply system using a high-pressure fuel supply pump (fuel pump) according to the present embodiment will be described with reference to FIG. 1.

FIG. 1 is an overall configuration diagram of a fuel supply system using a high-pressure fuel supply pump according to the present embodiment of the present invention.

As shown in FIG. 1, the fuel supply system includes a high-pressure fuel supply pump (fuel pump) 100, an engine control unit (ECU) 101, a fuel tank 103, a common rail 106, and a plurality of injectors 107. The components of the high-pressure fuel supply pump 100 are incorporated integrally into a pump body 1 (Hereinafter, “body 1”.).

A fuel in the fuel tank 103 is pumped up by a feed pump 102 that is driven based on a signal from the ECU 101. The pumped up fuel is pressurized by a pressure regulator (not illustrated) into the fuel with a proper pressure, which is sent through a low-pressure pipe 104 to a low-pressure fuel suction inlet 51 of the high-pressure fuel supply pump 100.

The high-pressure fuel supply pump 100 pressurizes the fuel supplied from the fuel tank 103 and pressure-transfers the fuel to the common rail 106. The common rail 106 is fitted with the plurality of injectors 107 and with a fuel pressure sensor 105.

The plurality of injectors 107 are fitted such that the number of the injectors matches the number of cylinders (combustion chambers). The plurality of injectors 107 inject the fuel according to a drive current outputted from the ECU 101. The fuel supply system of this embodiment is a so-called direct injection engine system in which the injectors 107 inject the fuel directly into cylinders of an engine.

The fuel pressure sensor 105 outputs detected pressure data to the ECU 101. Based on engine status data (e.g., a crank rotation angle, a throttle opening degree, an engine rotating speed, a fuel pressure, etc.), the ECU 101 calculates a proper fuel injection amount (target fuel injection length), a proper fuel pressure (target fuel pressure), or the like.

Based on a result of calculation of the fuel pressure (target fuel pressure) or the like, the ECU 101 controls driving of the high-pressure fuel supply pump 100 and the plurality of injectors 107. Specifically, the ECU 101 includes a pump control unit that controls the high-pressure fuel supply pump 100, and an injector control unit that controls the injectors 107.

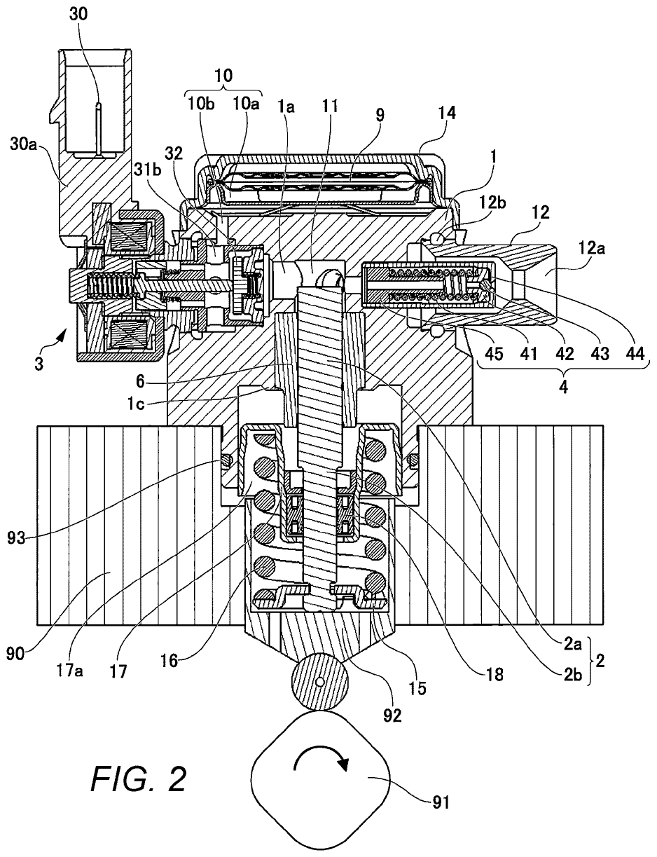

The high-pressure fuel supply pump 100 includes a pressure pulsation reducing mechanism m 9, a solenoid suction valve mechanism (solenoid valve mechanism) 3 that is a variable capacity mechanism, a relief valve mechanism 4 (see FIG. 2), and a discharge valve mechanism 8. The fuel flowing in through the low-pressure fuel suction inlet 51 flows through the pressure pulsation reducing mechanism 9 and a suction pass 10b and finally reaches a suction port 31b of the solenoid suction valve mechanism 3.

The fuel having flown into the solenoid suction valve mechanism 3 passes through a suction valve 32, flows through a suction pass 1a formed on the body 1, and then flows into a pressurized chamber 11. In the pressurized chamber 11, a plunger 2 is held in such a way as to be capable of reciprocating. To the plunger 2, power from a cam 91 (see FIG. 2) of the engine is transmitted, which causes the plunger 2 to reciprocate.

In the pressurized chamber 11, the fuel is sucked in from the solenoid suction valve mechanism 3 in a moving down stroke of the plunger 2, whereas the fuel is pressurized in an moving up stroke of the plunger 2. When a fuel pressure in the pressurized chamber 11 exceeds a given value, the discharge valve mechanism 8 opens, and the high-pressure fuel is pressure-transferred through a fuel discharge opening 12a to the common rail 106. Fuel discharge by the high-pressure fuel supply pump 100 is adjusted by opening/closing of the solenoid suction valve mechanism 3. Opening/closing of the solenoid suction valve mechanism 3 is then controlled by the ECU 101.

### [High-Pressure Fuel Supply Pump]

A configuration of the high-pressure fuel supply pump 100 will then be described with reference to FIGS. 2 to 4.

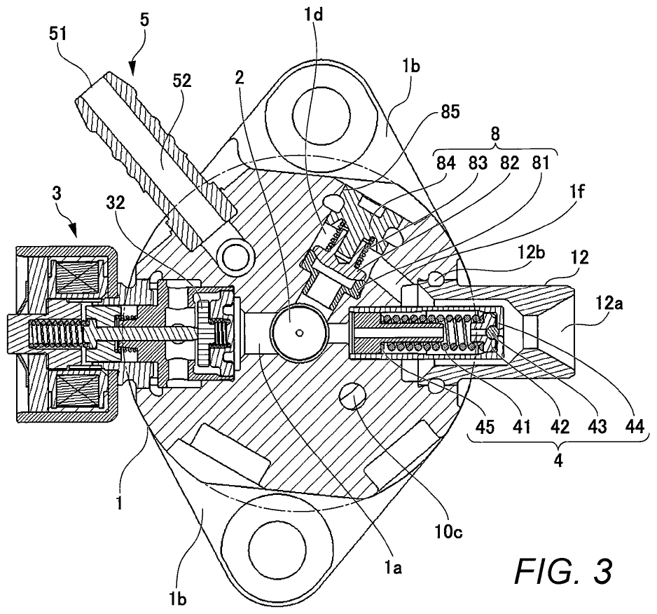

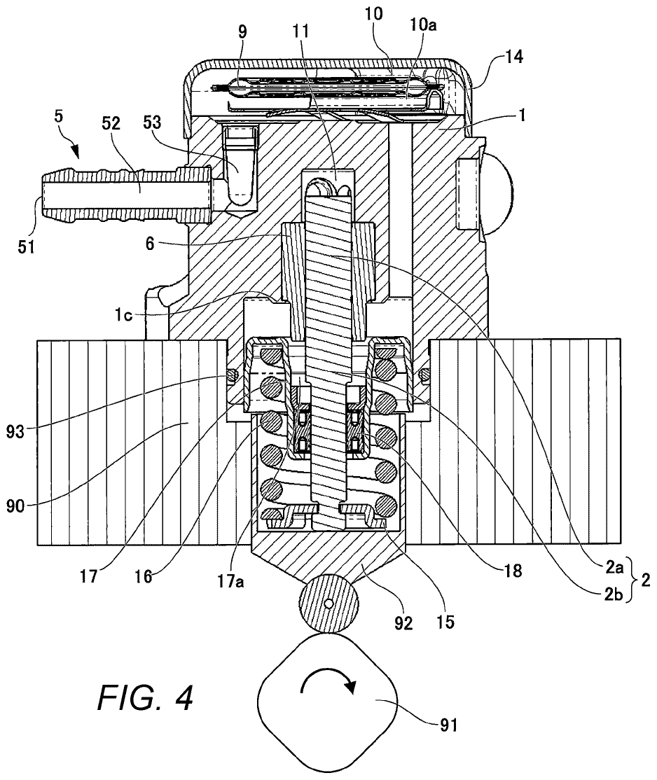

FIG. 2 is a vertical sectional view of the high-pressure fuel supply pump 100. FIG. 3 is a horizontal sectional view of the high-pressure fuel supply pump 100, showing a section perpendicular to the vertical direction of high-pressure fuel supply pump 100. FIG. 4 is a vertical sectional view of the high-pressure fuel supply pump 100, the vertical sectional view being seen from a direction different from a direction in which the vertical sectional view of FIG. 2 is seen.

As shown in FIGS. 2 and 3, the body 1 of the high-pressure fuel supply pump 100 is provided with the above suction pass 1a and a mounting flange 1b (see FIG. 3). The mounting flange 1b is attached closely to a fuel pump mounting portion 90 of the engine (internal combustion engine). The mounting flange 1b is fixed to the fuel pump mounting portion 90, using a plurality of bolts or screws (not illustrated). In other words, the high-pressure fuel supply pump 100 is fixed to the fuel pump mounting portion 90 via the mounting flange 1b.

As shown in FIGS. 2 and 4, an O-ring 93, which is a specific example of a seat member, is interposed between the fuel pump mounting portion 90 and the body 1. This O-ring 93 prevents engine oil from flowing through between the fuel pump mounting portion 90 and the body 1 and leaking out of the engine (internal combustion engine).

To the body 1 of the high-pressure fuel supply pump 100, a cylinder 6 is fitted, which guides the reciprocation of the plunger 2. The cylinder 6 is of a cylindrical shape. The outer periphery of the cylinder 6 is press-fitted in a cylinder housing recess formed on the body 1. The body 1 and the cylinder 6, together with the solenoid suction valve mechanism 3, the plunger 2, and the discharge valve mechanism 8 (see FIG. 3), form the pressurized chamber 11.

The body 1 has a fixing part 1c engaged with a central part in the axial direction of the cylinder 6. The fixing part 1c of the body 1 pushes the cylinder 6 upward (the upper side in FIG. 2). This prevents the fuel pressurized in the pressurized chamber 11 from leaking from a gap between an upper end surface of the cylinder 6 and the body 1.

A lower end of the plunger 2 is provided with a tappet 92. The tappet 92 converts the rotational movement of a cam 91 attached to a cam shaft of the engine into a vertical movement and transmits the vertical movement to the plunger 2. The plunger 2 is biased toward the cam 91 by a spring 16 via a retainer 15. The lower end of the plunger 2 is thus press-fitted to the tappet 92. The tappet 92 reciprocates as a result of rotation of the cam 91. The plunger 2 reciprocates together with the tappet 92 to change the capacity of the pressurized chamber 11.

A seal holder 17 is disposed between the cylinder 6 and the retainer 15. The seal holder 17 is of a cylindrical shape into which the plunger 2 is inserted. Between an upper part of the seal holder 17 and the pump body 1, an auxiliary chamber 17a is formed. The seal holder 17 holds a plunger seal 18 on its lower end closer to the retainer 15.

The plunger seal 18 is slidably in contact with the outer periphery of the plunger 2. When the plunger 2 reciprocates, the plunger seal 18 seals up the auxiliary chamber 17a to prevent the fuel in the auxiliary chamber 17a from flowing into the engine. The plunger seal 18 also prevents lubricating oil (including engine oil) lubricating sliding parts in the engine from flowing into the body 1.

In FIG. 2, the plunger 2 reciprocates in the vertical direction. When the plunger 2 moves down, the capacity of the pressurized chamber 11 increases. When the plunger 2 moves up, the capacity of the pressurized chamber 11 decreases. In this manner, the plunger 2 is disposed in such a way as to reciprocate in the direction of increasing and decreasing the capacity of the pressurized chamber 11.

The plunger 2 has a large diameter part 2a and a small diameter part 2b. When the plunger 2 reciprocates, the large diameter part 2a and the small diameter part 2b are in the auxiliary chamber 17a. The volume of the auxiliary chamber 17a is, therefore, increased or decreased by the reciprocation of the plunger 2.

The auxiliary chamber 17a communicates with a low-pressure fuel chamber 10 through a fuel pass 10c (see FIG. 3). When the plunger 2 moves down, it creates a flow of the fuel from the auxiliary chamber 17a to the low-pressure fuel chamber 10. When the plunger 2 moves up, it creates a flow of the fuel from the low-pressure fuel chamber 10 to the auxiliary chamber 17a. Because of these processes, a flow rate of the fuel pumped in and out by the pump can be reduced in a suction stroke or a return stroke of the high-pressure fuel supply pump 100. As a result, pressure pulsation that develops in the high-pressure fuel supply pump 100 can be reduced.

As shown in FIGS. 3 and 4, a suction joint 5 is fitted to the side of the body 1. The suction joint 5 is connected to a low-pressure pipe 104 (see FIG. 1) through which the fuel supplied from the fuel tank 103 flows. The fuel in the fuel tank 103 is supplied from the suction joint 5 into the high-pressure fuel supply pump 100.

The suction joint 5 includes a low-pressure fuel suction inlet 51 connected to the low-pressure pipe 104 and a suction channel 52 communicating with the low-pressure fuel suction inlet 51. As shown in FIG. 4, a suction filter 53 is placed in a fuel pass communicating with the suction channel 52. The suction filter 53 removes foreign matter from the fuel and prevents entry of foreign matter in the high-pressure fuel supply pump 100. The fuel having passed through the suction channel 52 flows through the pressure pulsation reducing mechanism 9 and the suction pass 10b (see FIG. 2), which are provided in the low-pressure fuel chamber 10, and reaches the suction port 31b (see FIG. 2) of the solenoid suction valve mechanism 3.

As shown in FIG. 2, the body 1 of the high-pressure fuel supply pump 100 is provided with the low-pressure fuel chamber 10. The low-pressure fuel chamber 10 is covered with a damper cover 14. The low-pressure fuel chamber 10 is provided with a low-pressure fuel channel 10a and the suction pass 10b. The suction pass 10b communicates with a suction port 31b (see FIG. 2) of the solenoid suction valve mechanism 3. The fuel having flown through the low-pressure fuel channel 10a further flows through the suction pass 10b to reach the suction port 31b of the solenoid suction valve mechanism 3.

The low-pressure fuel channel 10a is provided with the pressure pulsation reducing mechanism 9. When the fuel having entered the pressurized chamber 11 flows through the solenoid suction valve mechanism 3 in an open-valve state again and is returned to the suction pass 10b (see FIG. 2), pressure pulsation occurs in the low-pressure fuel chamber 10. The pressure pulsation reducing mechanism 9 reduces spread of the pressure pulsation having occurred in the high-pressure fuel supply pump 100 to the low-pressure pipe 104.

The pressure pulsation reducing mechanism 9 has a metal diaphragm damper constructed by pasting together two corrugated-plate-like metal discs on their outer peripheries. An inert gas, such as argon, is injected into the metal diaphragm damper. The metal diaphragm damper expands and contracts to absorb or reduce pressure pulsation.

As shown in FIG. 3, the discharge valve mechanism 8 is connected to the outlet side of the pressurized chamber 11. The discharge valve mechanism 8 is housed in a discharge valve chamber 1d formed in the body 1. The discharge valve mechanism 8 includes a discharge valve seat member 81, and a discharge valve 82 that comes into contact with and separates from the discharge valve seat member 81. The discharge valve mechanism 8 includes a discharge valve spring 83 that biases the discharge valve 82 toward the discharge valve seat member 81, and a discharge valve stopper 84 that determines an amount of lift (movement distance) of the discharge valve 82. The discharge valve stopper 84 and the body 1 are welled together at a contact part 85.

The discharge valve chamber 1d is a substantially columnar space extending horizontally. One end of the discharge valve chamber 1d communicates with the pressurized chamber 11. The other end of the discharge valve chamber 1d is open on the side of the body 1. The opening on the other end of the discharge valve chamber 1d is sealed by the discharge valve stopper 84.

To the body 1, a discharge joint 12 is welded by a welding part 12b. The discharge joint 12 has a fuel discharge opening 12a. The fuel discharge opening 12a communicates with the discharge valve chamber 1d via a discharge pass 1f. The discharge pass 1f extends horizontally inside the body 1. The fuel discharge opening 12a is connected to the common rail 106 (see FIG. 1).

In a state where a fuel pressure in the pressurized chamber 11 is lower than a fuel pressure in the discharge valve chamber 1d, the discharge valve 82 is brought into pressure contact with the discharge valve seat member 81 because of a pressure difference acting on the discharge valve 82 and a biasing force applied by the discharge valve spring 83. This puts the discharge valve mechanism 8 in a closed-valve state. When the fuel pressure in the pressurized chamber 11 becomes larger than the fuel pressure in the discharge valve chamber 1d and a pressure difference acting on the discharge valve 82 becomes larger than the biasing force applied by the discharge valve spring 83, on the other hand, the discharge valve 82 separates from the discharge valve seat member 81. This puts the discharge valve mechanism 8 in an open-valve state.

When the discharge valve mechanism 8 is put in the open-valve state, the fuel is discharged from the pressurized chamber 11 and flows through the discharge valve chamber 1d, the discharge pass 1f, and the fuel discharge opening 12a of the discharge joint 12 to reach the common rail 106 (see FIG. 1). In the configuration described above, the discharge valve mechanism 8 functions as a check valve that limits the direction of flow of the fuel.

As shown in FIGS. 2 and 3, the body 1 is provided with a relief valve mechanism 4 communicating with the pressurized chamber 11. The relief valve mechanism 4 includes a relief spring 41, a relief valve holder 42, a relief valve 43, a seat member 44, and a spring support member 45.

The seat member 44 is of a bottomed cylindrical shape. The seat member 44 holds therein the relief spring 41, the relief valve holder 42, the relief valve 43, and the support member 45. The support member 45 is disposed closer to the pressurized chamber 11. The bottom of the seat member 44 is located opposite to the pressurized chamber 11. The bottom of the seat member 44 has a through-hole serving as a fuel pass.

One end of the relief spring 41 is in contact with the spring support member 45. The other end portion of the relief spring 41 is in contact with the relief valve holder 42. The relief spring 41 biases the relief valve holder 42 toward the bottom of the seat member 44. The relief valve 43 is disposed between the relief valve holder 42 and the bottom of the seat member 44.

The relief valve 43 is engaged with the relief valve holder 42. The relief valve 43, together with the relief valve holder 42, is biased toward the bottom of the seat member 44. The relief valve 43 thus closes the fuel pass of the seat member 44. The fuel pass of the seat member 44 communicates with the discharge pass 1f (see FIG. 3). Fuel transfer between the pressurized chamber 11 (upstream side) and the seat member 44 (downstream side) is cut off by the relief valve 43 kept in contact with (firmly stuck to) the seat member 44.

When the pressure of the fuel in the common rail 106 and members downstream thereto rises, the fuel in the seat member 44 presses the relief valve 43. As a result, the relief valve 43 overcomes the biasing force of the relief spring 41 and moves in a direction against the biasing force. As a result, the relief valve mechanism 4 opens, and the fuel in the discharge pass 1f flows through the fuel pass of the seat member 44 back to the pressurized chamber 11. In this manner, a pressure that forces the relief valve 43 to open is determined, depending on the biasing force of the relief spring 41.

While the relief valve mechanism 4 of this embodiment communicates with the pressurized chamber 11, the configuration of the relief valve mechanism 4 is not limited to this case. The relief valve mechanism according to the present invention may communicate with, for example, a low-pressure pass (the low-pressure fuel suction inlet 51, the suction pass 10b, or the like).

### [Solenoid Suction Valve Mechanism]

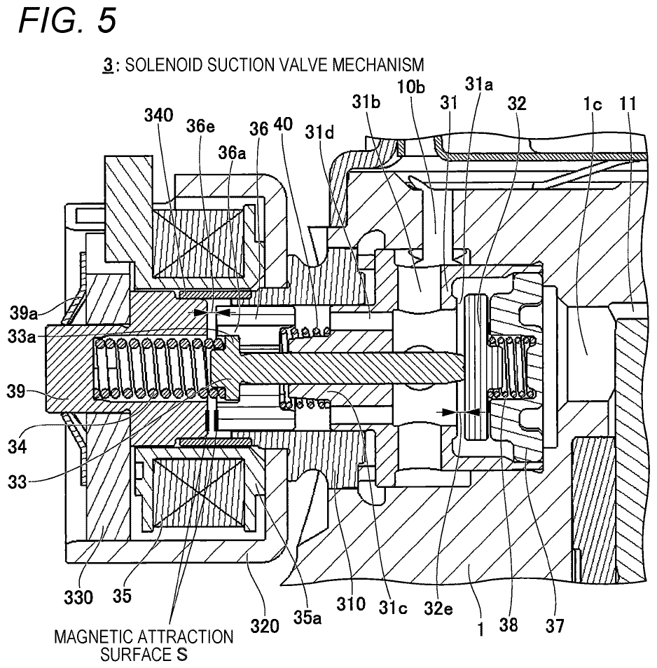

Next, the solenoid suction valve mechanism 3 will then be described with reference to FIG. 5.

FIG. 5 is an enlarged vertical sectional view of the solenoid suction valve mechanism 3 of the high-pressure fuel supply pump 100, showing the open-valve state of the solenoid suction valve mechanism 3.

As shown in FIG. 5, the solenoid suction valve mechanism 3 is inserted into a lateral hole formed in the body 1. The solenoid suction valve mechanism 3 includes a suction valve seat 31 press-fitted in the lateral hole formed on the body 1, a suction valve 32, a rod 33, a rod biasing spring 34, an electromagnetic coil 35, and an anchor 36. The suction valve 32 is a specific example of a valve according to the present invention. The anchor 36 is a specific example of a movable core according to the present invention.

The suction valve seat 31 is of a cylindrical shape. The inner periphery of the suction valve seat 31 is provided with a seating part 31a. On the suction valve seat 31, a suction port 31b is formed, which extends from the inner periphery to the outer periphery. The suction port 31b communicates with the suction pass 10b in the above-described low-pressure fuel chamber 10.

The suction valve seat 31 has a rod guide 31c through which the rod 33 penetrates. The rod guide 31c is of a cylindrical shape. In addition to a cylindrical hole through which the rod 33 penetrates, the rod guide 31c has a communication pass 31d penetrating it in the axial direction. Because of this configuration, when the anchor 36 moves in the axial direction, the anchor 36 does not hamper the movement of the fuel in the solenoid suction valve mechanism 3.

In the lateral hole formed in the body 1, a stopper 37 is placed, which is counter to the seating part 31a of the suction valve seat 31. The suction valve 32 is disposed between the stopper 37 and the seating part 31a. Between the stopper 37 and the suction valve 32, a valve biasing spring 38 is interposed. The valve biasing spring 38 biases the suction valve 32 toward the seating part 31a.

By coming in contact with the seating part 31a, the suction valve 32 closes a communication portion between the suction port 31b and the pressurized chamber 11. This puts the solenoid suction valve mechanism 3 in the closed-valve state. By coming in contact with the stopper 37, on the other hand, the suction valve 32 opens the communication portion between the suction port 31b and the pressurized chamber 11. This puts the solenoid suction valve mechanism 3 in the open-valve state.

The rod 33 penetrates the rod guide 31c of the suction valve seat 31 and the anchor 36. The rod 33 has a rod flange 33a formed thereon. The rod flange 33a is engaged with one end of the rod biasing spring 34. The other end of the rod biasing spring 34 is engaged with a fixed core 39 surrounding the rod biasing spring 34. The rod biasing spring 34 biases the suction valve 32 in a valve-open direction, i.e., toward the stopper 37 via the rod 33.

The anchor 36 is formed in a substantially cylindrical shape. In addition to a cylindrical hole through which the rod 33 penetrates, the anchor 36 has a communication pass 36a penetrating it in the axial direction. Because of this configuration, when the anchor 36 moves in the axial direction, the anchor 36 does not hamper the movement of the fuel in the solenoid suction valve mechanism 3.

With one end in the axial direction of the anchor 36, one end of the anchor biasing spring 40 is in contact. The other end in the axial direction of the anchor 36 is counter to an end surface of the fixed core 39. On the other end in the axial direction of the anchor 36, a flange contact part is formed, with which the rod flange 33a of the rod 33 comes in contact.

The other end of the anchor biasing spring 40 is in contact with a rod guide 31c. The anchor biasing spring 40 biases the anchor 36 toward the rod flange 33a of the rod 33. A movement allowed distance 36e of the anchor 36 is set longer than a movement allowed distance 32e of the suction valve 32. This allows the suction valve 32 to certainly come in contact with (to certainly sit on) the seating part 31a. As a result, the solenoid suction valve mechanism 3 can be certainly put in the closed-valve state.

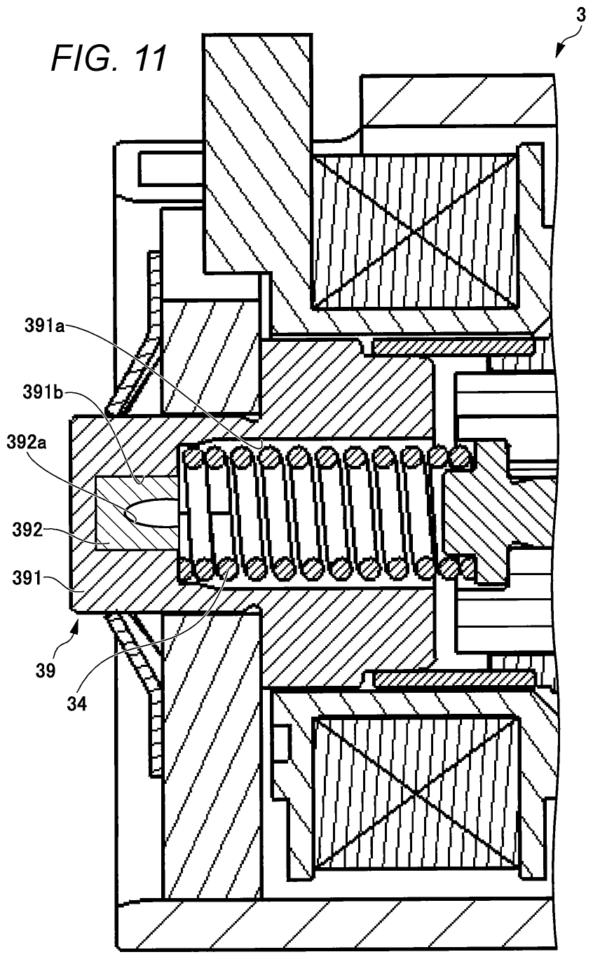

The fixed core 39 is of a bottomed cylindrical shape. In other words, the fixed core 39 has a recess extending in the axial direction. In the recess of the fixed core 39, the rod biasing spring 34 is inserted. With the bottom surface of the recess of the fixed core 39, the other end of the rod biasing spring 34 is in contact. The recess of the fixed core 39 will be described later with reference to FIG. 11.

To the opening of the lateral hole formed in the body 1, an outer core 310 is connected. The outer core 310 is of a substantially cylindrical shape. The outer periphery of one end in the axial direction of the outer core 310 is fitted into the lateral hole formed on the body 1. The outer core 310 is fixed to the body 1 by welding.

With the inner periphery of the outer core 310, the anchor 36 is slidably engaged. In other words, the anchor 36 is guided by the inner periphery of the outer core 310 and moves in the axial direction (open-valve direction and closed-valve direction). The other end in the axial direction of the outer core 310 projects from the body 1. On the outer periphery of the other end in the axial direction of the outer core 310, a first yoke 320 is fitted. The outer core 310 is press-fitted and fixed in the first yoke 320.

The first yoke 320 is of a bottomed cylindrical shape surrounding an electromagnetic coil 35. The fixed core 39 projects from the opening side of the first yoke 320. At the center of the bottom of the first yoke 320, a fitting hole is formed for fitting the first yoke 320 on the outer core 310.

The opening of the first yoke 320 is closed with a second yoke 330. The second yoke 330 is a substantially annular plate material. Almost at the center of the second yoke 330, a circular through-hole is formed. The fixed core 39 penetrates the through-hole of the second yoke 330. A part of fixed core 39 that projects from the second yoke 330 has a fixing pin 39a fixed to the part. The fixing pin 39a biases the second yoke 330 toward the anchor 36.

The first yoke 320 and the second yoke 330 jointly make up a magnetic circuit. The second yoke 330 is made of the same material as the first yoke 320 is made of. For example, a magnetic stainless steel may be used as the material of the first yoke 320 and the second yoke 330.

The electromagnetic coil 35 is disposed inside the first yoke 320 in such a way as to make a circle around the fixed core 39. The electromagnetic coil 35 is formed of a copper wire wound around a bobbin 35a multiple times. To the electromagnetic coil 35, the terminal member 30 (see FIG. 2) is electrically connected. The electromagnetic coil 35 carries a flow of current supplied through the terminal member 30.

In a non-energized state where the electromagnetic coil 35 carries no current flow, the rod 33 is biased in the open-valve direction by the rod biasing spring 34, thus pushing the suction valve 32 in the open-valve direction. As a result, the suction valve 32 separates from the seating part 31a and comes in contact with the stopper 37, which puts the solenoid suction valve mechanism 3 in the open-valve state. In other words, the solenoid suction valve mechanism 3 is a normal open type valve mechanism that opens in the non-energized state.

The terminal member 30 is disposed in a recess of the connector 30a (see FIG. 2). The connector 30a is molded integrally with the terminal member 30 and the electromagnetic coil 35. The connector 30a penetrates a cutout of the first yoke 320. A lower part of the connector 30a is counter to the second yoke 330. The second yoke 330 has a cutout for avoiding interference with the connector 30a.

On the inner peripheral side of the electromagnetic coil 35, a sealing 340 is disposed. The sealing 340 is of a cylindrical shape. In one end in the axial direction of the sealing 340, the outer core 310 is inserted. In the other end in the axial direction of the sealing 340, the fixed core 39 is inserted.

Outer peripheral surfaces of the fixed core 39 and outer core 310 form a peripheral surface matching a peripheral surface of the sealing 340 when the fixed core 39 and outer core 310 are inserted in the sealing 340. This facilitates attachment of other components, such as the bobbin 35a.

The sealing 340 is made of a material that is thin and that can be changed in shape (expanded and contracted). The sealing 340 has a larger elongation percentage than the fixed core 39 and the anchor 36. The sealing 340 has, for example, an elongation percentage of 35% or more. The sealing 340 is a non-magnetic material. As the material of the sealing 340, for example, an austenitic stainless steel is preferable.

When the solenoid suction valve mechanism 3 is in the open-valve state, the fuel in the suction port 31b flows through between the suction valve 32 and the seating part 31a and further flows through a plurality of fuel passage hole (not shown) of the stopper 37 and the suction pass 1a to enter the pressurized chamber 11. When the solenoid suction valve mechanism 3 is in the open-valve state, the suction valve 32 comes in contact with the stopper 37 and therefore the position of the suction valve 32 in the open-valve direction is regulated. When the solenoid suction valve mechanism 3 is in the open-valve state, a gap between the suction valve 32 and the seating part 31a is equivalent to the movement allowed distance 32e of the suction valve 32, which movement allowed distance 32e is an open-valve stroke.

A current flow in the electromagnetic coil 35 generates magnetic flux. The generated magnetic flux passes through the fixed core 39, the second yoke 330, the first yoke 320, the outer core 310, and the anchor 36, which make up a magnetic path. Because of this, a magnetic attractive force acts on respective magnetic attraction surfaces S of the anchor 36 and the fixed core 39. As a result, the anchor 36 overcomes the biasing force of the rod biasing spring 34 to move against the direction of the biasing force and comes in contact with the fixed core 39.

When the anchor 36 moves toward the fixed core 39, that is, moves in the closed-valve direction, the rod 33, which is engaged with the anchor 36, moves together with the anchor 36. As a result, the suction valve 32 is released from the biasing force acting in the open-valve direction, and is forced to move in the closed-valve direction by the biasing force of the valve biasing spring 38. When the suction valve 32 comes in contact with the seating part 31a of the suction valve seat 31, the solenoid suction valve mechanism 3 is put in the closed-valve state.

### [Operation of High-Pressure Fuel Supply Pump]

Operation of the high-pressure fuel pump according to this embodiment will then be described with reference to FIG. 2.

In FIG. 2, in a case where the plunger 2 moves down when the solenoid suction valve mechanism 3 is in the open-valve state, the fuel flows from the suction pass 1a into the pressurized chamber 11. Hereinafter, a stroke in which the plunger 2 moves down will be referred to as a suction stroke. In a case where the plunger 2 moves up when the solenoid suction valve mechanism 3 is in the closed-valve state, on the other hand, the fuel in the pressurized chamber 11 is pressurized. As a result, the fuel in the pressurized chamber 11 is pressure-transferred through the discharge valve mechanism 8 to the common rail 106 (see FIG. 1). Hereinafter, a stroke in which the plunger 2 moves up will be referred to as a compression stroke.

When the solenoid suction valve mechanism 3 is in the closed-valve state during the compression stroke, the fuel sucked into the pressurized chamber 11 during the suction stroke is pressurized and is discharged toward the common rail 106.

When the solenoid suction valve mechanism 3 is in the open-valve state during the compression stroke, however, the fuel sucked into the pressurized chamber 11 is pushed back toward the suction pass 1a and is therefore not discharged toward the common rail 106. In this manner, fuel discharge by the high-pressure fuel supply pump 100 is an operation determined by whether the solenoid suction valve mechanism 3 is opened or closed. Opening/closing of the solenoid suction valve mechanism 3 is then controlled by the ECU 101.

In the suction stoke, the capacity of the pressurized chamber 11 increases, resulting in a drop in a fuel pressure in the pressurized chamber 11. As a result, the fuel pressure in the pressurized chamber 11 becomes lower than a fuel pressure in the suction port 31b. When a biasing force created by a difference between both fuel pressures exceeds the biasing force by the valve biasing spring 38, the suction valve 32 separates from the seating part 31a. This puts the solenoid suction valve mechanism 3 in the open-valve state. As a result, the fuel in the suction port 31b flows through between the suction valve 32 and the seating part 31a and further flows through the plurality of holes formed on the stopper 37 to enter the pressurized chamber 11.

Following the end of the suction stroke, the compression stroke starts. At this point, the electromagnetic coil 35 remains in the non-energized state and therefore no magnetic attractive force acts between the anchor 36 and the fixed core 39. Meanwhile, to the suction valve 32, a biasing force in the open-valve direction is applied, the biasing force corresponding to a difference in biasing force between the anchor biasing spring 40 and the rod biasing spring 34. In addition to that, to the suction valve 32, a fluid pressure (pressure in the closed-valve direction) is also applied, the fluid pressure being generated when the fuel flows from the pressurized chamber 11 back to the low-pressure fuel channel 10a.

In this state, to allow the solenoid suction valve mechanism 3 to maintain its open-valve state, the difference in biasing force between the anchor biasing spring 40 and the rod biasing spring 34 is set larger than the fluid pressure. The capacity of the pressurized chamber 11 decreases as the plunger 2 moves up. This causes the fuel sucked into the pressurized chamber 11 to flow through between the suction valve 32 and the suction valve seat 31 and reenters the suction port 31b. The fuel pressure in the pressurized chamber 11, therefore, does not rise. This stroke is referred to as a return stroke.

In this return stoke, when a control signal from the ECU 101 (see FIG. 1) is applied to the solenoid suction valve mechanism 3, a current supplied through the terminal member 30 flows in the electromagnetic coil 35. This current flow in the electromagnetic coil 35 creates a magnetic attractive force, which acts on the magnetic attraction surfaces S of the fixed core 39 and the anchor 36, thus causing the anchor 36 to be attracted to the fixed core 39.

When the magnetic attractive force becomes larger than the biasing force of the rod biasing spring 34, the anchor 36 overcomes the biasing force of the rod biasing spring 34 and moves toward the fixed core 39 (in the valve-closed direction). As a result, the rod 33 engaged with the anchor 36 moves in the direction of separating away from the suction valve 32. As a result, the biasing force by the valve biasing spring 38 and the fluid pressure by the fuel flowing into the suction pass 10b force the suction valve 32 to sit on the seating part 31a. When the suction valve 32 sits on the seating part 31a, the solenoid suction valve mechanism 3 is put in the closed-valve state.

After the solenoid suction valve mechanism 3 is put in the closed-valve state, the fuel in the pressurized chamber 11 is pressurized as the plunger 2 moves up. When the pressure to the fuel rises to a given pressure or higher pressure, the fuel is discharged from the pressurized chamber 11 to flow through the discharge valve mechanism 8 into the common rail 106 (see FIG. 1). This process is referred to as a discharge process. In other words, the compression stroke in which the plunger 2 moves from a bottom dead center to a top dead center is made up of the return stroke and the discharge stroke. By controlling timing of supplying current to the electromagnetic coil 35 of the solenoid suction valve mechanism 3, an amount of the discharge high-pressure fuel can be controlled.

Advancing timing of supplying current to the electromagnetic coil 35 reduces the ratio of the return stroke while increasing the ratio of the discharge stroke during the compression stroke. As a result, the fuel returned to the suction pass 10b decreases as the fuel discharged under high pressure increases. Delaying timing of supplying current to the electromagnetic coil 35, on the other hand, increases the ratio of the return stroke while reducing the ratio of the discharge stroke during the compression stroke. As a result, the fuel returned to the suction pass 10b increases as the fuel discharged under high pressure decreases. In this manner, by controlling timing of supplying current to the electromagnetic coil 35, the amount of the fuel discharged under high pressure can be adjusted to an amount the engine (internal combustion engine) needs.

### [Cavitation and Erosion That Occur in Fixed Core]

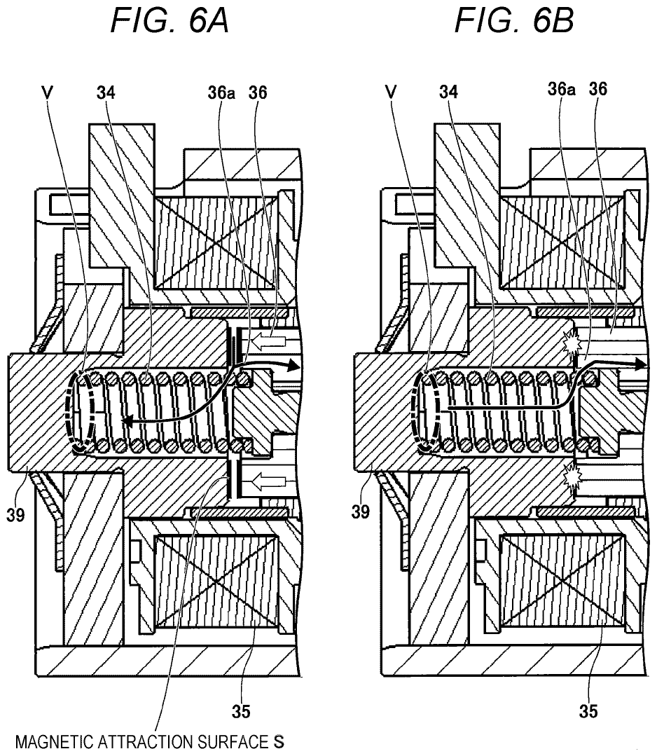

Cavitation and erosion that occur in the recess of the fixed core 39 will then be described with reference to FIGS. 6 to 9.

(When Fixed Core and Movable Core Are in Contact with Each Other)

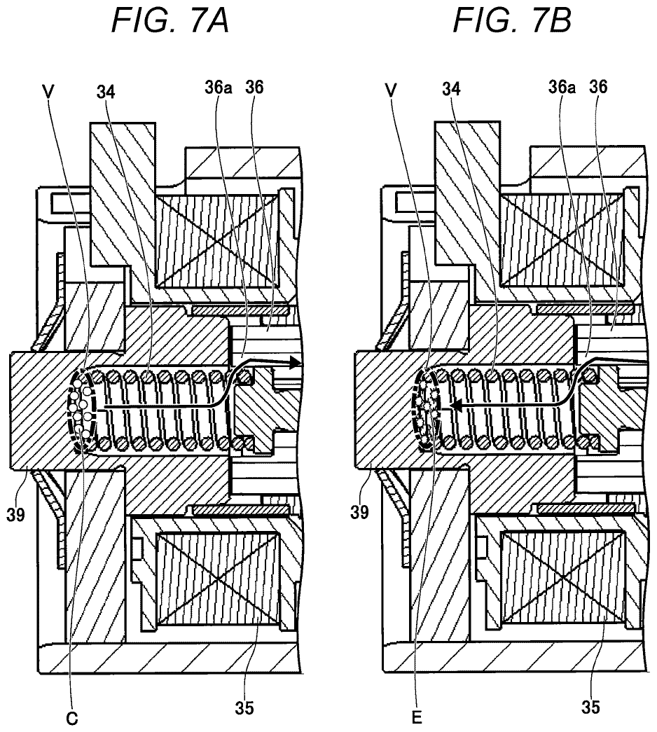

First, cavitation and erosion that occur in the recess of the fixed core 39 when the fixed core 39 and the anchor 36 are in contact with each other will be described with reference to FIGS. 6 and 7.

FIG. 6A depicts a state in which the fixed core 39 and the anchor 36 are separated from each other. FIG. 6B depicts a moment at which the anchor 36 comes in contact with the fixed core 39. FIG. 7A depicts a state in which the anchor 36 is in contact with the fixed core 39 and cavitation occurs. FIG. 7B is depicts a state in which erosion occurs.

As shown in FIG. 6A, as a result of supplying current to the electromagnetic coil 35, a magnetic attractive force is generated on the magnetic attraction surfaces S of the fixed core 39 and the anchor 36. As a result, the anchor 36 moves in the direction of approaching the fixed core 39 (to the left in FIG. 6A).

When the anchor 36 approaches the fixed core 39, a fluid (fuel) present between the anchor 36 and the fixed core 39 flows into the communication pass 36a of the anchor 36 and into the recess of the fixed core 39 (hereinafter, the recess of the fixed core 39 will be referred to as “fixed core recess”). At this time, an area V near the bottom surface of the fixed core recess provides no place for the fluid to escape. As a result, the fuel in the area V is highly pressurized.

As shown in 6B, the anchor 36 moves in the direction of approaching the fixed core 39 and collides with the fixed core 39. The anchor 36 thus stops moving and becomes in a state of in contact with the fixed core 39.

When the anchor 36 stops moving, a flow of the fluid into the fixed core recess stops. Following this, the highly pressurized fluid in the fixed core recess flows from the fixed core recess toward the communication pass 36a of the anchor 36. As a result, the pressure of the fluid in the area V of the fixed core recess gradually decreases.

As shown in FIG. 7A, due to an inertial force, the fluid in the fixed core recess continues to flow toward the communication pass 36a. As a result, the pressure of the fluid in the area V of the fixed core recess continues to drop. When the pressure of the fluid in the area V drops below a saturated vapor pressure, cavitation C occurs in the area V in the fixed core recess.

Afterward, as shown in 7B, the pressure of the fluid in the area V, in which the cavitation has occurred, recovers. This happens because of a pressure wave that is created when the fluid flowing out of the fixed core recess collides with a nearby component and is reflected by it or reentry of the fluid into the fixed core recess caused by a drop in the pressure of the fluid in the fixed core recess.

When the pressure of the fluid in the area V of the fixed core recess recovers, the cavitation C having occurred in the area V of the fixed core recess collapses. Impact created by collapse of the cavitation gives erosive damage to the fixed core 39, thus causing erosion E.

(When Fixed Core and Movable Core Are Separated from Each Other)

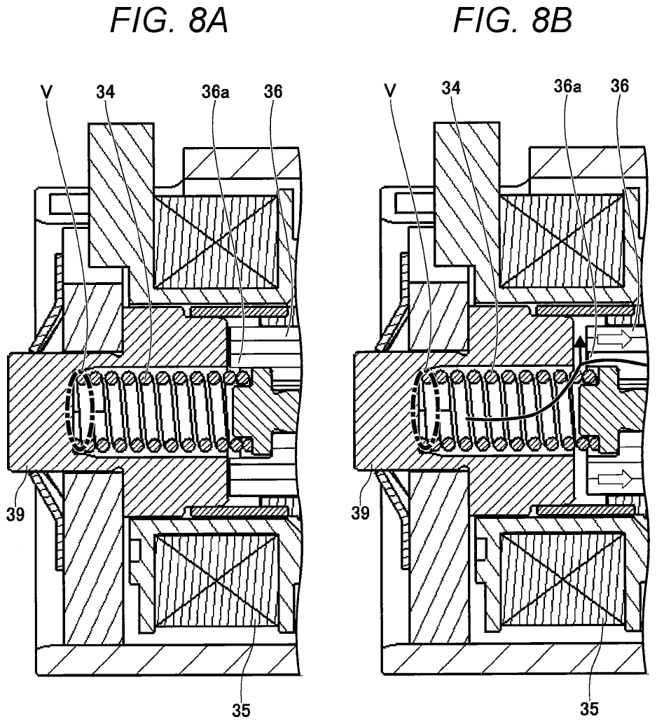

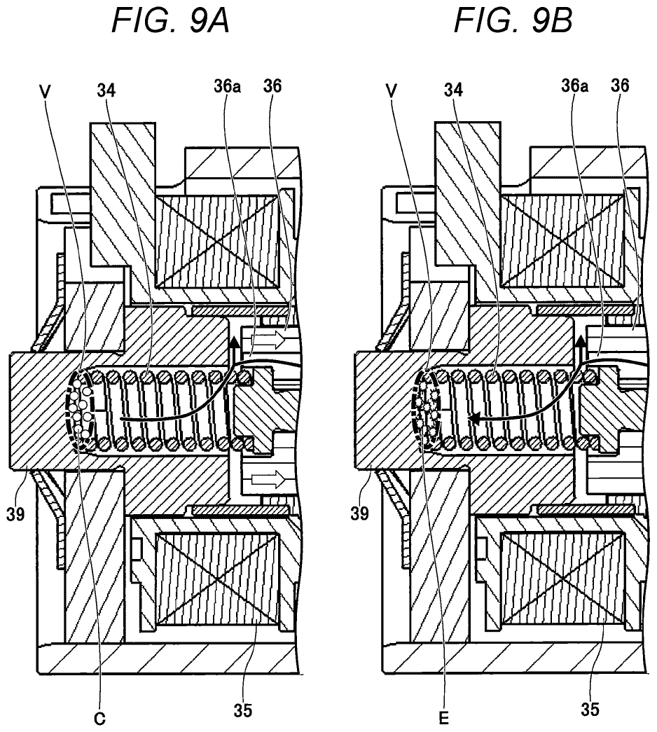

Cavitation and erosion that occur in the recess of the fixed core 39 when the fixed core 39 and the anchor 36 are separated from each other will then be described with reference to FIGS. 8 and 9.

FIG. 8A depicts a state in which the fixed core 39 and the anchor 36 are in contact with each other. FIG. 8B depicts a state in which the anchor 36 is in the middle of a process of separating away from the fixed core 39. FIG. 9A depicts a state in which cavitation occurs when the anchor 36 is in the middle of process of separating away from the fixed core 39. FIG. 9B depicts a state in which erosion occurs.

As shown in FIG. 8A, when the anchor 36 is in contact with the fixed core 39 at a point of time before the anchor 36 separates from the fixed core 39, no capacity change occurs in the vicinity of the fixed core recess inside the solenoid suction valve mechanism 3. A change in the pressure of the fluid in the area V of the fixed core recess, therefore, does not occur. As a result, the fluid is in a hydrostatic pressure state.

As shown in FIG. 8B, when the anchor 36 moves in the direction of separating away from the fixed core 39 (to the right in FIG. 8), the fluid flows from the communication pass 36a and the fixed core recess into a gap between the fixed core 39 and the anchor 36. As a result, the pressure of the fluid in the area V of the fixed core recess drops.

As shown in FIG. 9A, when the pressure of the fluid in the area V of the fixed core recess continues to drop, the pressure of the fluid in the area V drops below the saturated vapor pressure. As a result, cavitation C occurs in the area V of the fixed core recess.

Afterward, as shown in 9B, the pressure of the fluid in the area V, in which the cavitation has occurred, recovers. This happens because of a pressure wave created by stoppage of the moving anchor 36 or reentry of the fluid into the fixed core recess caused by a drop in the pressure of the fluid in the fixed core recess.

When the pressure of the fluid in the area V of the fixed core recess recovers, the cavitation C having occurred in the area V of the fixed core recess collapses. Impact created by collapse of the cavitation gives erosive damage to the fixed core 39, thus causing erosion E.

The area V of the fixed core recess is under a severe environment where the risk of cavitation and erosion gets higher as the moving speed of the anchor 36 gets higher. Meanwhile, in recent years, a high-pressure fuel pump offering a higher discharge pressure and a higher flow rate is in demand. Meeting this demand requires an increase in the amount of lift of the cam 91. Now the moving speed of the anchor 36 is qualitatively correlated with the amount of lift of the cam 91. Therefore, to meet the demand for a high-pressure fuel pump offering a higher discharge pressure and a higher flow rate, it is necessary to improve robustness against cavitation and erosion in the area V of the fixed core recess.

Besides, diversification of fuel has been promoted in recent years. A fuel with a low saturated vapor pressure is apt to develop cavitation. For this reason, diversification of fuel requires improvement of robustness against cavitation and erosion.

When cavitation and erosion have occurred and a component of the solenoid suction valve mechanism 3 is damaged by the cavitation and erosion, it is possible that the cavitation and erosion make a hole on the component, thus causing fuel leakage from the holes. Even if a hole is not made on the component, there may be a case where a chipped portion of the component becomes a foreign object that causes malfunction of the solenoid suction valve mechanism 3. Therefore, improvement of robustness against cavitation and erosion is required.

### [Erosion Resistance of Rubber Material]

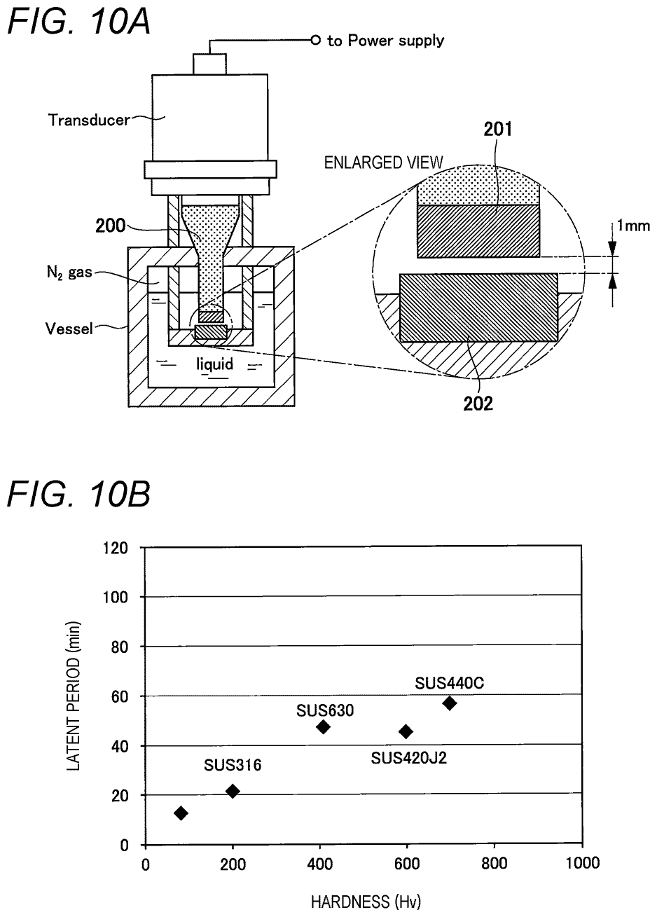

Erosion resistance of a rubber material will then be described with reference to FIG. 10.

FIG. 10A is a conceptual diagram of a vibration-type cavitation test device. FIG. 10B is a diagram of a test result by the vibration-type cavitation test device.

The vibration-type cavitation test device vibrates a horn 200 vertically to cause pressure fluctuations, thereby causing cavitation. A test piece 202 is set counter to a front end 201 of the horn 200. The vibration-type cavitation test device can check the progress of erosion resulting from cavitation of the test piece 202.

A test result under certain test conditions is shown in a graph of 10B. The horizontal axis of the graph of FIG. 10B represents hardness (Vickers hardness), and the vertical axis of the graph of FIG. 10B represents a latent period preceding the occurrence of erosion. As shown in FIG. 10B, a material with hardness of Hv400 or more has a latent period of about 40 minutes to 60 minutes. In contrast, a rubber material has a latent period of 120 minutes or more, which gives a confirmation that the rubber material has high erosion resistance. The rubber material does not possess hardness that can be expressed in Vickers hardness. Therefore, the latent period of the rubber material is not plotted on the graph of FIG. 10B.

### [Configuration of Fixed Core]

A configuration of the fixed core 39 according to the first embodiment will then be described with reference to FIG. 11.

FIG. 11 is an enlarged vertical sectional view of the fixed core 39 according to the first embodiment.

As shown in FIG. 11, the fixed core 39 includes a fixed core body 391, and a rubber member 392 fitted to the fixed core body 391. The fixed core body 391, which is made of a metal material, is formed into a bottomed cylindrical shape. The fixed core body 391 has a first recess 391a, into which the rod biasing spring 34 is inserted, and a second recess 391b, which is opened to the bottom surface of the first recess 391a.

The first recess 391a is of a substantially columnar shape. With the bottom surface of the first recess 391a, the other end of the above rod biasing spring 34 is in contact. The second recess 391b is open at the center of the bottom surface of the first recess 391a. The second recess 391b is counter to an axial hole of the rod biasing spring 34. The second recess 391b is of a substantially columnar shape.

The rubber member 392 corresponds to an elastic member according to the present invention. The rubber member 392 is of a substantially columnar shape that is substantially the same in diameter as the second recess 391b. The rubber member 392 is press-fitted and fixed in the second recess 391b. The rubber member 392 covers the whole of an inner wall surface of the second recess 391b.

The rubber member 392 is formed into the shape that is substantially the same as the second recess 391b. An end surface of rubber member 392 that is closer to the rod biasing spring 34 forms the same plane as the bottom surface of the first recess 391a forms. The rubber member 392 is of a shape that does not come in contact with the bottom surface of the first recess 391a. In other words, the rubber member 392 is not interposed between the bottom surface of the first recess 391a and the rod biasing spring 34.

The rubber member 392 is provided with a recess 392a. The recess 392a is opened to the end surface of rubber member 392 that is closer to the rod biasing spring 34. The recess 392a is formed into a substantially egg shape in consideration of moldability of the rubber material. The fuel enters the first recess 391a of the fixed core body 391 and the recess 392a of the rubber member 392. The fuel, however, does not enter the second recess 391b of the fixed core body 391.

In the solenoid suction valve mechanism 3 using such a fixed core 39, cavitation and erosion concentrate in the recess 392a of the rubber member 392. Therefore, occurrence of cavitation and erosion in an area located closer to the rod biasing spring 34 (the first recess 391a) than the rubber member 392 can be suppressed.

In addition, the inner wall surface of the second recess 391b of the fixed core body 391 is not in contact with the fuel. This suppresses occurrence of erosion on the inner wall surface of the second recess 391b. In this manner, by fitting the rubber member 392 in the second recess 391b, occurrence of erosion in the fixed core body 391 made of the metal material can be suppressed.

The bottom surface of the second recess 391b according to this embodiment is formed into a flat surface. However, the bottom surface of the second recess 391b according to the present invention may be formed into a curved surface or a tapered surface in consideration of easiness in processing.

### 2. Second Embodiment

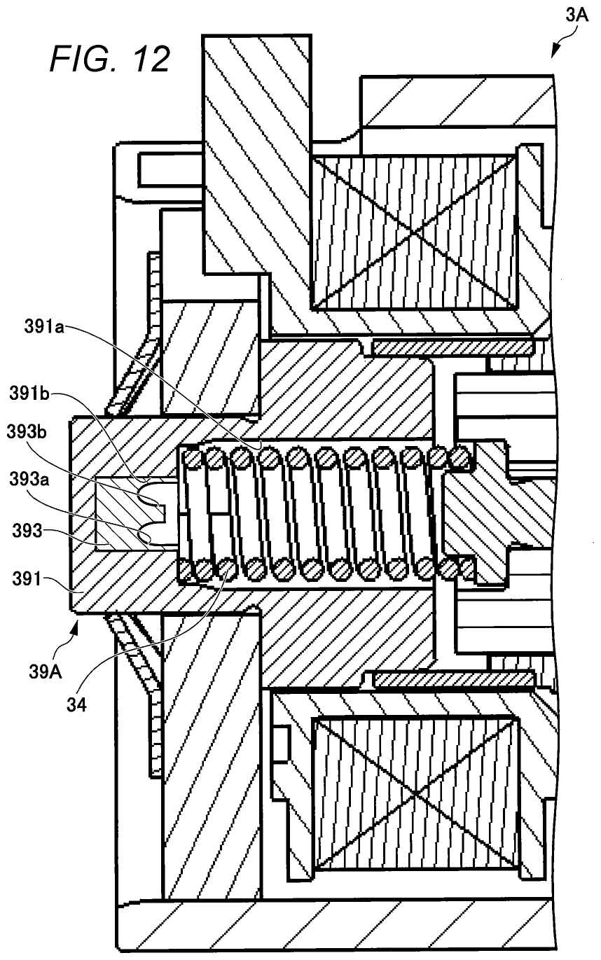

A solenoid suction valve mechanism according to a second embodiment of the present invention will then be described with reference to FIG. 12.

FIG. 12 is an enlarged vertical sectional view of a fixed core according to the second embodiment.

A solenoid suction valve mechanism 3A according to the second embodiment has a configuration similar to that of the solenoid suction valve mechanism 3 according to the first embodiment. The solenoid suction valve mechanism 3A is different from the solenoid suction valve mechanism 3 in that the solenoid suction valve mechanism 3A includes a fixed core Therefore, the fixed core 39A will be described, and 39A. description of the same configuration as that of the solenoid suction valve mechanism 3 will be omitted.

As shown in FIG. 12, the fixed core 39A includes the fixed core body 391, and a rubber member 393 fitted to the fixed core body 391. This fixed core body 391 is the same as the fixed core body 391 of the first embodiment.

The rubber member 393 corresponds to the elastic member according to the present invention. The rubber member 393 is of a substantially columnar shape that is substantially the same in diameter as the second recess 391b. The rubber member 393 is press-fitted and fixed in the second recess 391b. The rubber member 393 covers the whole of the inner wall surface of the second recess 391b.

The rubber member 393 is formed into the shape that is substantially the same as the second recess 391b. An end surface of rubber member 393 that is closer to the rod biasing spring 34 forms the same plane as the bottom surface of the first recess 391a forms. The rubber member 393 is of a shape that does not come in contact with the bottom surface of the first recess 391a. In other words, the rubber member 393 is not interposed between the bottom surface of the first recess 391a and the rod biasing spring 34.

The rubber member 393 is provided with a recess 393a. The recess 393a is opened to the end surface of rubber member 392 that is closer to the rod biasing spring 34. The recess 393a is formed into a substantially columnar shape. The bottom surface of the recess 393a is formed into a hemispherical curved surface.

At the center of the bottom surface of the recess 393a, a projection 393b projecting toward the opening is formed. An end surface of the projection 393b is located in the recess 393a. The position of the projection 393b is set in consideration of a molding die for molding the rubber member 393 and a nozzle insertion position. In this manner, the rubber member according to the present invention is applicable when having the recess where cavitation and erosion concentrate, and the shape of the recess can be determined properly.

The fuel enters the first recess 391a of the fixed core body 391 and the recess 393a of the rubber member 393. The fuel, however, does not enter the second recess 391b of the fixed core body 391. In the solenoid suction valve mechanism 3A using such a fixed core 39A, cavitation and erosion concentrate in the recess 393a of the rubber member 393. Therefore, occurrence of cavitation and erosion in an area located closer to the rod biasing spring 34 (the first recess 391a) than the rubber member 393 can be suppressed.

In addition, the inner wall surface of the second recess 391b of the fixed core body 391 is not in contact with the fuel. This suppresses occurrence of erosion on the inner wall surface of the second recess 391b. In this manner, by fitting the rubber member 393 in the second recess 391b, occurrence of erosion in the fixed core body 391 made of the metal material can be suppressed.

### 3. Third Embodiment

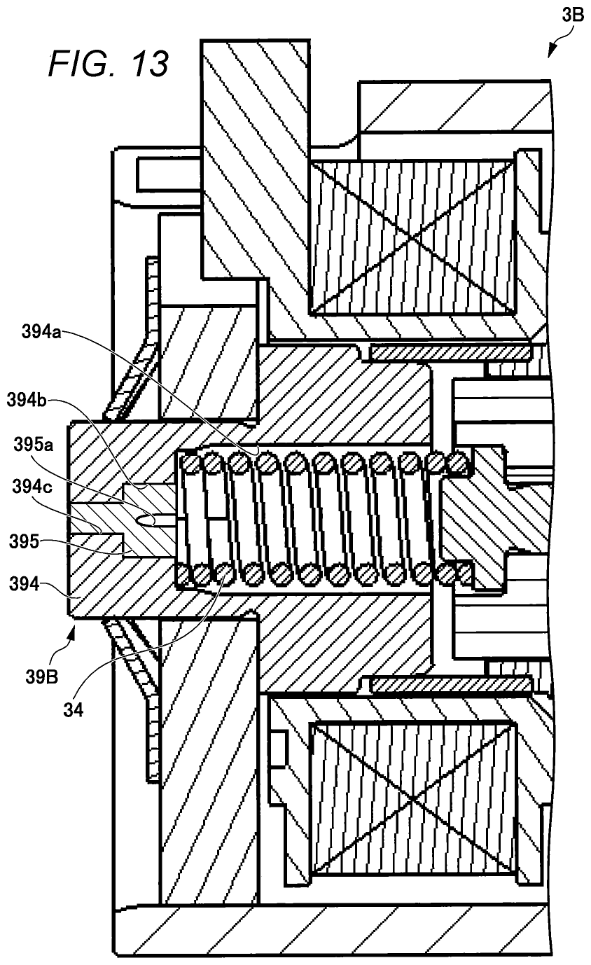

A solenoid suction valve mechanism according to a third embodiment of the present invention will then be described with reference to FIG. 13.

FIG. 13 is an enlarged vertical sectional view of a fixed core according to the third embodiment.

A solenoid suction valve mechanism 3B according to the third embodiment has a configuration similar to that of the solenoid suction valve mechanism 3 according to the first embodiment. The solenoid suction valve mechanism 3B is different from the solenoid suction valve mechanism 3 in that the solenoid suction valve mechanism 3B includes a fixed core 39B. Therefore, the fixed core 39B will be described, and description of the same configuration as that of the solenoid suction valve mechanism 3 will be omitted.

As shown in FIG. 13, the fixed core 39B includes a fixed core body 394, and a rubber member 395 fitted to the fixed core body 394. The fixed core body 394, which is made of a metal material, is formed into a bottomed cylindrical shape. The fixed core body 394 has a first recess 394a, into which the rod biasing spring 34 is inserted, and a second recess 394b, which is opened to the bottom surface of the first recess 394a, and a communication port 394c open to the bottom surface of the second recess 394b.

The first recess 394a is of a substantially columnar shape. With the bottom surface of the first recess 394a, the other end of the above rod biasing spring 34 is in contact. The second recess 394b is open at the center of the bottom surface of the first recess 394a. The second recess 394b is counter to the axial hole of the rod biasing spring 34. The second recess 394b is of a substantially columnar shape. The communication port 394c extends to reach an end surface on the bottom side of the fixed core body 394.

The rubber member 395 corresponds to the elastic member according to the present invention. The rubber member 395 is integrally molded (e.g., insert molding) with the fixed core body 394. When the fixed core 39B is molded, the rubber material is injected from the communication port 394c toward the second recess 394b. This prevents a case where a nozzle that injects the rubber material and the fixed core body 394 interfere with each other. As a result, molding the rubber member 395 is made easy.

The rubber member 395 fills the second recess 394b and the communication port 394c. The rubber member 395, therefore, covers the whole of an inner wall surface of the second recess 394b and of an inner wall surface of the communication port 394c.

The rubber member 395 is formed into a shape substantially the same as the shape of the second recess 394b and the communication port 394c. An end surface of rubber member 395 that is closer to the rod biasing spring 34 forms the same plane as the bottom surface of the first recess 394a forms. The rubber member 395 is of a shape that does not come in contact with the bottom surface of the first recess 394a. In other words, the rubber member 395 is not interposed between the bottom surface of the first recess 394a and the rod biasing spring 34.

The rubber member 395 is provided with a recess 395a. The recess 395a is opened to the end surface of rubber member 395 that is closer to the rod biasing spring 34. The recess 395a is formed into a substantially egg shape in consideration of moldability of the rubber material. The fuel enters the first recess 394a of the fixed core body 394 and the recess 395a of the rubber member 395. The fuel, however, does not enter the second recess 394b and the communication port 394c of the fixed core body 394.

In the solenoid suction valve mechanism 3B using such a fixed core 39B, cavitation and erosion concentrate in the recess 395a of the rubber member 395. Therefore, occurrence of cavitation and erosion in an area located closer to the rod biasing spring 34 (the first recess 394a) than the rubber member 395 can be suppressed.

In addition, the inner wall surface of the second recess 394b of the fixed core body 394 is not in contact with the fuel. This suppresses occurrence of erosion on the inner wall surface of the second recess 394b. In this manner, by fitting the rubber member 395 in the second recess 394b, occurrence of erosion in the fixed core body 394 made of the metal material can be suppressed.

### 4. Fourth Embodiment

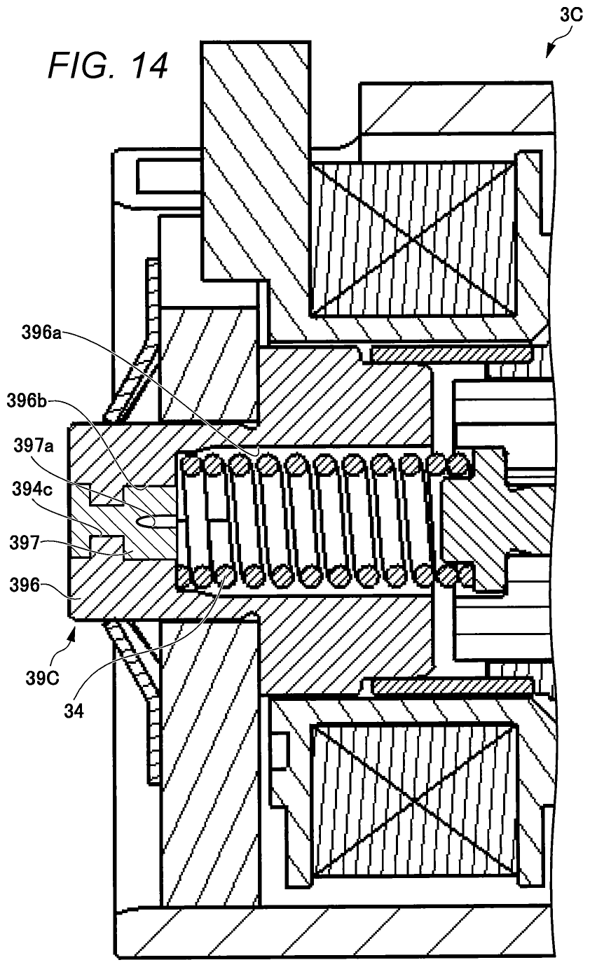

A solenoid suction valve mechanism according to a fourth embodiment of the present invention will then be described with reference to FIG. 14.

FIG. 14 is an enlarged vertical sectional view of a fixed core according to the fourth embodiment.

A solenoid suction valve mechanism 3C according to the fourth embodiment has a configuration similar to that of the solenoid suction valve mechanism 3 according to the first embodiment. The solenoid suction valve mechanism m 3C is different from the solenoid suction valve mechanism 3 in that the solenoid suction valve mechanism 3C includes a fixed core 39C. Therefore, the fixed core 39C will be described, and description of the same configuration as that of the solenoid suction valve mechanism 3 will be omitted.

As shown in FIG. 14, the fixed core 39C includes a fixed core body 396, and a rubber member 397 fitted to the fixed core body 396. The fixed core body 396, which is made of a metal material, is formed into a bottomed cylindrical shape. The fixed core body 396 has a first recess 396a, into which the rod biasing spring 34 is inserted, and a second recess 396b, which is opened to the bottom surface of the first recess 396a, and a communication port 396c open to the bottom surface of the second recess 396b.

The first recess 396a is of a substantially columnar shape. With the bottom surface of the first recess 396a, the other end of the above rod biasing spring 34 is in contact. The second recess 396b is open at the center of the bottom surface of the first recess 396a. The second recess 396b is counter to the axial hole of the rod biasing spring 34. The second recess 396b is of a substantially columnar shape.

The communication port 396c extends to reach an end surface on the bottom side of the fixed core body 394. The communication port 396c is shaped such that two columns having different diameters are lined up in the axial direction. The communication port 396c has a large diameter part opened to the bottom side of the fixed core body 394, and small diameter part communicating with the large diameter part and with the second recess 396b. The large diameter part is larger in diameter than the small diameter part.

The rubber member 397 corresponds to the elastic member according to the present invention. The rubber member 397 is integrally molded (e.g., insert molding) with the fixed core body 396. When the fixed core 39C is molded, the rubber material is injected from the communication port 396c toward the second recess 396b. This prevents a case where a nozzle that injects the rubber material and the fixed core body 394 interfere with each other. As a result, molding the rubber member 397 is made easy.

The large diameter part on the inlet side of the communication port 396c (the side opposite to the second recess 396b) is a space larger than the small diameter part closer to the second recess 396b. The large diameter part thus accommodates nozzles of various sizes that inject the rubber material.

The rubber member 397 fills the second recess 396b and the communication port 396c. The rubber member 397, therefore, covers the whole of an inner wall surface of the second recess 396b and of an inner wall surface of the communication port 396c.

The rubber member 397 is formed into a shape that is substantially the same as the shape of the second recess 396b and communication port 396c. An end surface of rubber member 397 that is closer to the rod biasing spring 34 forms the same plane as the bottom surface of the first recess 396a forms. The rubber member 397 is of a shape that does not come in contact with the bottom surface of the first recess 396a. In other words, the rubber member 397 is not interposed between the bottom surface of the first recess 396a and the rod biasing spring 34.

The rubber member 397 is provided with a recess 397a . . . . The recess 397a is opened to the end surface of rubber member 397 that is closer to the rod biasing spring 34. The recess 397a is formed into a substantially egg shape in consideration of moldability of the rubber material. The fuel enters the first recess 396a of the fixed core body 396 and the recess 397a of the rubber member 397. The fuel, however, fuel does not enter the second recess 396b of the fixed core body 396 and the communication port 396c.

In the solenoid suction valve mechanism 3C using such a fixed core 39C, cavitation and erosion concentrate in the recess 397a of the rubber member 397. Therefore, occurrence of cavitation and erosion in an area located closer to the rod biasing spring 34 (the first recess 394a) than the rubber member 397 can be suppressed.

In addition, the inner wall surface of the second recess 396b of the fixed core body 396 is not in contact with the fuel. This suppresses occurrence of erosion on the inner wall surface of the second recess 396b. In this manner, by fitting the rubber member 397 in the second recess 396b, occurrence of erosion in the fixed core body 396 made of the metal material can be suppressed.

### 5. Summary

As described above, the above-described solenoid suction valve mechanism 3 (solenoid valve mechanism) includes the suction valve 32 (valve), the rod 33 engaged with the suction valve 32, and the anchor 36 (movable core) engaged with the rod 33. The solenoid suction valve mechanism 3 further includes the fixed core 39 that generates a magnetic attractive force between the fixed core 39 and the anchor 36, and the rod biasing spring 34 that biases the rod 33 in the direction of separating the rod 33 away from the fixed core 39. The fixed core 39 includes the first recess 391a having the bottom surface with which the one end of the rod biasing spring 34 comes in contact, the second recess 391b formed on the bottom surface of the first recess 391a, and the rubber member 392 (elastic member) housed in the second recess 391b. The rubber member 392 covers the whole of an inner wall surface of the second recess 391b.

This prevents the fuel from entering the second recess 391b of the fixed core 39. As a result, occurrence of erosion on the inner wall surface of the second recess 391b can be suppressed.

The rubber member 392 (elastic member) of the above-described solenoid suction valve mechanism 3 (solenoid valve mechanism) is provided with the recess 392a formed on a surface in contact with the fuel.

As a result, cavitation and erosion concentrate in the recess 392a of the rubber member 392. Therefore, occurrence of cavitation and erosion in the first recess 391a located closer to the rod biasing spring 34 than the rubber member 392 can be suppressed.

The rubber member 392 (elastic member) of the above-described solenoid suction valve mechanism 3 (solenoid valve mechanism) may project in such a way as to be closer to the rod biasing spring 34 than the bottom surface of the first recess 391a.

This makes the axial length of the rubber member 392 larger than the depth of the second recess 391b. As a result, the minimum allowable size of the rubber member 392 can be set to the depth of the second recess 391b, which facilitates manufacturing of the rubber member 392.

The rubber member 395 (elastic member) of the above-described solenoid suction valve mechanism 3B (solenoid valve mechanism) is filled into the second recess 394b and is fixed or bonded to the second recess 394b.

Hence the rubber member 395 covering the whole of the inner wall surface of the second recess 394b can be formed easily.

The rubber member 392 (elastic member) of the above-described solenoid suction valve mechanism 3 (solenoid valve mechanism) is of the shape that is not in contact with the bottom surface of the first recess 391a.

Because of this, the rubber member 392 is not interposed between the bottom surface of the first recess 391a and the rod biasing spring 34. This prevents a case where the length of the rod biasing spring 34 in its compressed state is shorter than a set length. Hence the rod biasing spring 34 is able to bias the anchor 36 with a proper biasing force.

The rubber member 392 (elastic member) of the above-described solenoid suction valve mechanism 3 (solenoid valve mechanism) is of the shape that is not interposed between the bottom surface of the first recess 391a and the rod biasing spring 34.

This prevents a case where the length of the rod biasing spring 34 in its compressed state is shorter than a set length. Hence the rod biasing spring 34 is able to bias the anchor 36 with a proper biasing force.

The above-described high-pressure fuel supply pump 100 (fuel pump) includes the body 1 having the pressurized chamber 11, the plunger 2 that is supported by the body 1 in such a way as to be capable of reciprocation and that increases or decreases the capacity of the pressurized chamber 11 by the reciprocation, and the above-described solenoid suction valve mechanism 3 (solenoid valve mechanism) that discharges the fuel to the pressurized chamber 11.

Because of this configuration, the fuel does not enter the second recess 391b of the fixed core 39 of the solenoid suction valve mechanism 3. As a result, occurrence of erosion on the inner wall surface of the second recess 391b can be suppressed.

The embodiments of the solenoid valve mechanism and the fuel pump of the present invention, which include effects the embodiments offer, have been described above. However, the solenoid valve mechanism and the fuel pump of the present invention are not limited to the above-described embodiments, and can be modified in various forms within a range that does not depart from the substance of the invention described in the claims.

The above embodiments have been described in detail to give an understandable description of the present invention and are not necessarily limited to an embodiment including all constituent elements described above. Some of constituent elements of one embodiment can be replaced with constituent elements of another embodiment, and a constituent element of another embodiment can be added to a constituent element of one embodiment. Furthermore, some of constituent elements of each embodiment can be deleted or added to or replaced with different constituent elements.

For example, in the first and second embodiments described above, the rubber member 392 and 393 are each press-fitted and fixed in the second recess 391b. However, the rubber member (elastic member) according to the present invention may be bonded to the inner wall surface of the second recess, using an adhesive.

In the embodiments described above, the rubber members 392, 393, 395, and 397 are each used as the elastic member according to the present invention. However, the elastic member according to the present invention is not limited to the rubber member. An elastic member of a different material may be adopted properly, providing that the adopted elastic member can buffer shock waves caused by cavitation collapse. It is preferable that the elastic member according to the present invention, for example, be a member having a Poisson's ratio of 0.45 or more and 0.55 or less.

### REFERENCE SIGNS LIST

1 body
2 plunger
3, 3A, 3B, 3C solenoid suction valve mechanism (solenoid valve mechanism)
4 relief valve mechanism
5 suction joint
6 cylinder
8 discharge valve mechanism
9 pressure pulsation reducing mechanism
10 low-pressure fuel chamber
11 pressurized chamber
12 discharge joint
14 damper cover
15 retainer
17 seal holder
18 plunger seal
30 terminal member
31 suction valve seat
31a seating part
31b suction port
31c rod guide
31d communication pass
32 suction valve
33 rod
33a rod flange
35 electromagnetic coil
35a bobbin
36 anchor (movable core)
36a communication pass
37 stopper
39, 39A, 39B, 39C fixed core
39a fixing pin
51 low-pressure fuel suction inlet
52 suction channel
53 suction filter
90 fuel pump mounting portion
91 cam
92 tappet
93 O-ring
100 high-pressure fuel supply pump
101 ECU
102 feed pump
103 fuel tank
104 low-pressure pipe
105 fuel pressure sensor
106 common rail
107 injector
200 horn
201 front end
202 test piece
310 outer core
320 first yoke
330 second yoke
340 sealing
391, 394, 396 fixed core body
391a, 394a, 396a first recess
391b, 394b, 396b second recess
392, 393, 395, 397 rubber member
392a, 393a, 395a, 397a recess
393b projection
394c, 396c communication port

1. A solenoid valve mechanism comprising:
a valve;
a rod engaged with the valve;
a movable core engaged with the rod;
a fixed core that generates a magnetic attractive force between the fixed core and the movable core; and
a rod biasing spring that biases the rod in a direction of separating the rod away from the fixed core,
wherein the fixed core includes:
a first recess having a bottom surface with which one end of the rod biasing spring comes in contact;
a second recess formed on the bottom surface of the first recess; and
an elastic member housed in the second recess, and
wherein the elastic member covers a whole of an inner wall surface of the second recess.

2. The solenoid valve mechanism according to claim 1, wherein the elastic member is provided with a recess formed on a surface in contact with a fuel.

3. The solenoid valve mechanism according to claim 1, wherein the elastic member projects in such a way as to be closer to the rod biasing spring than the bottom surface of the first recess.

4. The solenoid valve mechanism according to claim 1, wherein the elastic member is filled into the second recess and is fixed or bonded to the second recess.

5. The solenoid valve mechanism according to claim 1, wherein the elastic member is of a shape that is not in contact with the bottom surface of the first recess.

6. The solenoid valve mechanism according to claim 1, wherein the elastic member is of a shape that is not interposed between the bottom surface of the first recess and the rod biasing spring.

7. A fuel pump comprising:
a body provided with a pressurized chamber;
a plunger supported by the body in such a way as to be capable of reciprocation, the plunger increasing and decreasing a capacity of the pressurized chamber by the reciprocation; and
a solenoid valve mechanism that discharges a fuel to the pressurized chamber,
wherein the solenoid valve mechanism includes:
a valve;
a rod engaged with the valve;
a movable core engaged with the rod;
a fixed core that generates a magnetic attractive force between the fixed core and the movable core; and
a rod biasing spring that biases the rod in a direction of separating the rod away from the fixed core,
wherein the fixed core includes:
a first recess having a bottom surface with which one end of the rod biasing spring comes in contact;
a second recess formed on the bottom surface of the first recess; and
an elastic member housed in the second recess, and
wherein the elastic member covers a whole of an inner wall surface of the second recess.
